(19) United States
(12) Patent Application Publication
(10) Pub. No.: US 2008/0025250 A1
(43) Pub. Date: Jan. 31, 2008

(54) METHOD AND SYSTEM FOR SETTING PAGING INDICATION SEQUENCES IN PAGING MESSAGES

(75) Inventors: Huai Y. Wang, Coconut Creek, FL (US); Floyd D. Simpson, Lake Worth, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Schaumburg, IL (US)

(21) Appl. No.: 11/460,771

(22) Filed: Jul. 28, 2006

(51) Int. Cl. H04Q 7/00; H04L 12/56

(52) U.S. Cl. 370/328; 370/411

(57) ABSTRACT

The invention concerns a method (200) and system (100) for setting a paging indication sequence (512) in paging messages (510). In one arrangement, the method can include the steps of—in a mixed media environment—receiving (212) incoming traffic designated for one or more mobile stations (112) in a paging group in which the mobile stations are capable of operating time-critical applications and ordering the paging indication sequence of the paging messages. The ordering can be performed such that higher priority identifiers (514) associated with the time-critical applications are positioned in front of lower priority identifiers (516) to reduce the connection set-up time for the time-critical applications of the mobile stations. As an example, the time-critical applications may be real-time applications, and the lower priority identifiers may be associated with non-real-time applications.

### BACKGROUND OF THE INVENTION

1. Field of the Invention

The present invention concerns the management of paging messages and more particularly, the management of such paging messages to improve the efficiency of mobile stations.

2. Description of the Related Art

The idle mode operation in the current specification for the Institute of Electrical and Electronics Engineers (IEEE) 802.16e defines periodic paging listening intervals that mobile subscriber stations (MSS) tune to in order to receive a series of broadcast paging messages from a base station (BS). Additionally, the BS may assign a number of MSSs to a particular paging group—depending on the functionality and/or desire of the MSSs—that has a predetermined paging cycle. The duration of a paging cycle may vary, with a shorter paging cycle typically reserved for groups of MSSs with time-sensitive applications, such as push-to-talk (PTT) (i.e., dispatch), which may lead to a paging cycle as short as 300 milliseconds (ms). Each listening interval defines the beginning of a paging cycle, and the listening intervals are comprised of one or more frames, the length of which some entities have set at 5 ms.

The 802.16e specification requires the BS to broadcast paging messages during the listening interval, and these paging messages contain information that will be processed by the MSSs receiving them to enable the MSSs to carry out the initiation of their relevant applications. In accordance with the 16e standard, all the MSSs of a paging group are required to process all the paging messages during a listening interval. The 16e specification, however, has no definition on how the broadcast paging messages should be constructed. Thus, the incoming session initiation message received by the BS is typically indicated in paging messages for transmission to the MSSs based on a first-in-first-out order.

As a result, an MSS that is paged for time-critical PTT set-up may receive such indication in a paging message after MSSs that are paged for less-time-critical applications, such as e-mail or Web browsing. In particular, the PTT-type paging indication may appear in the paging message transmitted in the last frame of a multi-frame listening interval. As each frame may be 5 ms long and there may be five frames in a listening interval, the amount of time before the MSS receives the PTT-type paging message may be increased by as much as 20 ms. Telecommunications companies are constantly seeking to reduce the connection time for PTT calls, and this delay is unacceptable.

### SUMMARY OF THE INVENTION

The present invention concerns a method for setting a paging indication sequence in paging messages. The method can include the step of—in a mixed media environment—receiving incoming traffic, such as session initiation messages, designated for one or more MSSs in a paging group in which the MSSs are capable of operating or enabled to operate time-critical applications. The method can also include the step of ordering the paging indication sequence of the paging messages such that higher priority identifiers associated with the time-critical applications are positioned in front of lower priority identifiers. This process can reduce the connection set-up time for the time-critical applications of the MSSs.

The method can also include the step of buffering the incoming traffic designated for the MSSs, and the ordering of the paging indication sequence may occur while the incoming traffic is buffered. The paging messages can be transmitted to the MSSs during a listening interval of a paging cycle. As an example, the listening interval can be comprised of one or more frames. In one arrangement, the time-critical applications may be real-time applications, and the lower priority identifiers may be associated with non-real-time applications. For example, the real-time applications may include PTT calls and Voice Over Internet Protocol (VOIP) calls, and the non-real-time applications can include e-mail and Web browsing.

In one embodiment, the incoming traffic can be comprised of Internet Protocol (IP) packets, and the method can further include the step of determining a priority of the incoming traffic by detecting a priority identifier in the IP packet. As an example, the priority identifier may be a Type of Service (ToS) flag, a Transmission Control Protocol (TCP) port number or a Quality of Service (QoS) field. As another example, the mixed media environment can be contained within a communications network that operates in accordance with the IEEE standard 802.16e.

The present invention also concerns a communication network for setting paging indication sequences in paging messages. The network can include a buffer that can receive incoming traffic designated for one or more MSSs in a paging group in which the MSSs are capable of operating time-critical applications and a paging controller operatively coupled to the buffer. The paging controller can order the paging indication sequence of the paging messages such that higher priority identifiers associated with the time-critical applications are positioned in front of lower priority identifiers to reduce the connection set-up time for the time-critical applications of the MSSs. The communication network can be a mixed media environment. This network may also include suitable software and circuitry to perform any of the processes described above.

The present invention also concerns a machine readable storage, having stored thereon a computer program having a plurality of code sections executable by an electronic device. The term “electronic device” can include any suitable number of components, including hardware and software. The computer program can cause the electronic device to—in a mixed media environment—receive incoming traffic designated for one or more MSSs in a paging group in which the MSSs are capable of operating time-critical applications. The computer program can also cause the electronic device to order a paging indication sequence of paging messages such that higher priority identifiers associated with the time-critical applications are positioned in front of lower priority identifiers. This process can reduce the connection set-up time for the time-critical applications of the MSSs. The computer program can also cause the electronic device to perform any of the steps described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a system for setting a paging indication sequence of paging messages in accordance with an embodiment of the inventive arrangements;

FIG. 2 illustrates a method for setting a paging indication sequence of paging messages in accordance with an embodiment of the inventive arrangements;

FIG. 3 illustrates an example of a paging cycle in accordance with an embodiment of the inventive arrangements;

FIG. 4 illustrates an example of an IP packet in accordance with an embodiment of the inventive arrangements; and

FIG. 5 illustrates an example of several frames, each having a paging message, in accordance with an embodiment of the inventive arrangements.

### DETAILED DESCRIPTION OF THE INVENTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled” as used herein, are defined as connected, although not necessarily directly, and not necessarily mechanically. The term “processor” can include any component or group of components, including any relevant hardware and/or software, that can carry out the functions described in relation to the inventive arrangements herein. The term “order” or “ordering” can mean the arrangement of any suitable form of information in accordance with a predefined protocol or set of rules.

The invention concerns a method and system for setting a paging indication sequence in paging messages. In one arrangement, the method can include the steps of—in a mixed media environment—receiving incoming traffic designated for one or more MSSs in a paging group in which the MSSs are capable of operating time-critical applications and ordering the paging indication sequence of the paging messages. The ordering can be performed such that higher priority identifiers associated with the time-critical applications are positioned in front of lower priority identifiers. This process can reduce the connection set-up time for the time-critical applications of the MSSs. As an example, the time-critical applications may be real-time applications, and the lower priority identifiers may be associated with non-real-time applications. For example, the real-time applications may include PTT calls and VOIP calls, and the non-real-time applications may include e-mail and Web browsing.

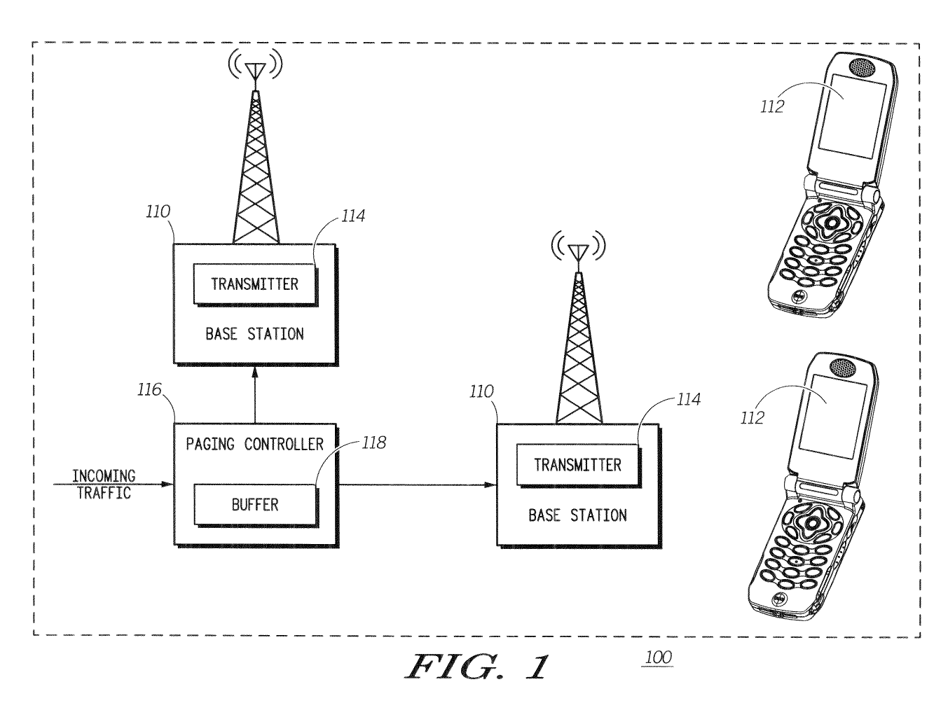

Referring to FIG. 1, a system or communication network 100 for setting a paging indication sequence in paging messages is shown. In one arrangement, the network 100 can include one or more BSs 110 and one or more MSSs 112, which are communicatively coupled. As an example, the BSs 110 can be implemented in a wide area network (WAN), although the invention is not so limited, as the BSs 110 can be part of any other suitable communications network. In fact, the term “base station” can refer to any component that is or components that are capable of exchanging wireless signals with any suitable number of mobile communications devices, As shown in FIG. 1, the BSs 110 can include a transmitter 114 that is capable of transmitting wireless signals to the MSSs 112.

The network 100 may also include one or more paging controllers 116. The paging controller 116 may be a stand-alone unit that is hard-wired or wirelessly coupled to the BSs 110. Alternatively, one or more of the BSs 110 may include the paging controller 116. As will be further explained below, the paging controller 116 may receive incoming traffic and can order paging indication sequences of paging messages in a manner that reduces the connection set-up time for certain applications of the MSSs 112. In one embodiment, the paging controller 116 can include a buffer 118 that can receive and buffer the incoming traffic. The incoming traffic can be for voice and/or data connections from any number of various sources, such as the Internet or some other communication network. In addition, the incoming traffic may be referred to as or comprised of session initiation messages, although the invention is not so limited.

As an example, the communication network 100 can be a network that operates in accordance with the IEEE standard 802.16e. As such, the network 100 may operate in a mixed media environment. A mixed media environment can be any setting where the exchange of any suitable data and voice is capable between mobile units and fixed network equipment. Examples include PTT or interconnect calls, short messaging service (SMS) applications, VOIP calls, e-mail and Internet or Web browsing. Of course, the invention is not limited to any of these particular examples.

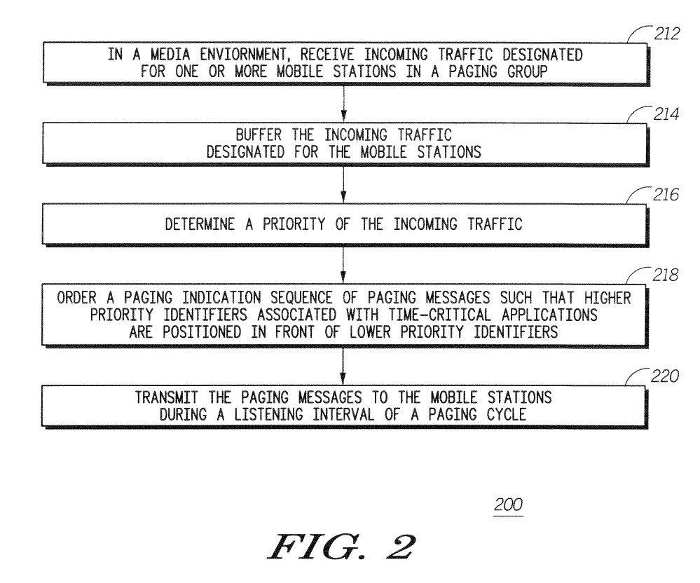

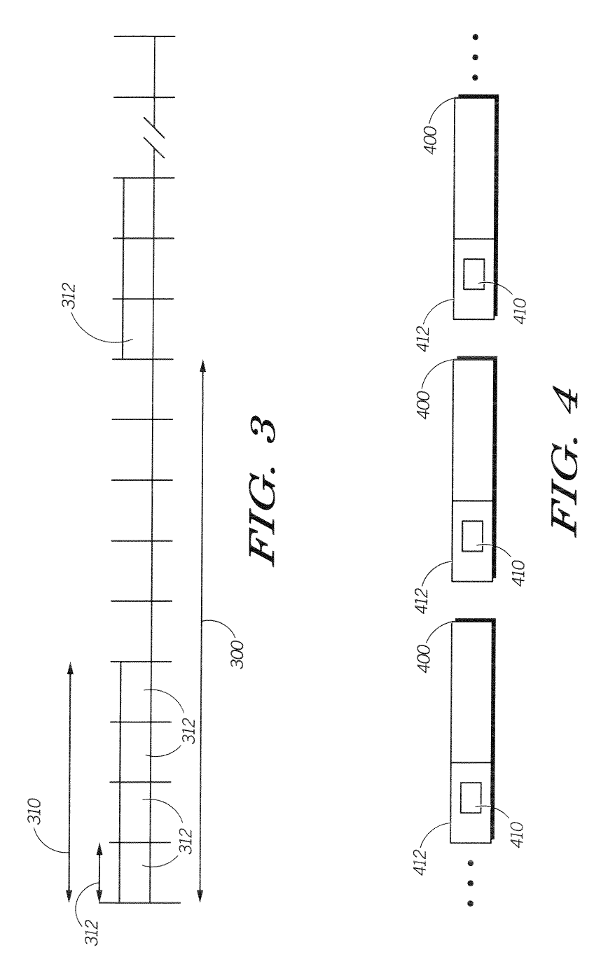

Referring to FIG. 2, a method 200 for setting a paging indication sequence of paging messages is shown. When describing the method 200, reference will be primarily made to FIG. 1, although it is understood that the method 200 can be practiced in any other suitable system or device. Reference may also be made to FIGS. 3 and 4, which respectively show an example of a paging cycle and an example of a paging indication sequence, although the invention is in no way limited to these particular examples. Moreover, the steps of the method 200 are not limited to the particular order in which they are presented in FIG. 2. The inventive method can also have a greater number of steps or a fewer number of steps than those shown in FIG. 2.

At step 210, in a mixed media environment, incoming traffic (such as session initiation messages) designated for one or more MSSs in a paging group can be received. At step 212, the incoming traffic designated for the MSSs can be buffered. A priority of the incoming traffic can be determined, as shown at step 214. To further describe these processes, reference will be made to FIGS. 1 and 3.

As is known in the art, the MSSs 112 may enter an idle mode to conserve battery life. For purposes of the invention, the term idle mode can refer to a mobile unit being de-registered from a communications network. During the idle mode, however, the MSSs 112 may still need to continue to periodically monitor for transmissions from the BSs 110. As such, a BS 110 can assign one or more of the MSSs 112 to a paging group having a predetermined paging cycle and listening interval.

An example of a paging cycle 300 is shown in FIG. 3, the duration of which is represented by the double arrow. In one arrangement, the paging cycle 300 can include one or more listening intervals 310 (duration also represented by a double arrow), and both the paging cycle 300 and the listening interval 310 can be comprised of one or more frames 312 (duration also represented by a double arrow). The listening interval 310 can define the beginning of the paging cycle 300, and the paging cycle 300 can be of any suitable duration. The MSSs 112 can monitor for transmissions from the BSs 110 during the listening interval 310 and can enter a low power state in which its receiver (or some other suitable component(s)) is temporarily turned off for the remainder of the paging cycle 300.

As noted earlier, the duration of a particular paging cycle 300 may depend on the applications or functions performed by the MSSs 112. In this example, the MSSs 112 can support dispatch communications, which can require a relatively short paging cycle 300 to reduce the set-up time for a PTT call. As such, this paging cycle 300 may be roughly 300 ms long, although it is understood that the paging cycle 300 can be of any other suitable duration. Also, the frames 312 may be of any suitable duration, although for purposes of this example, they may be considered 5 ms long and both the listening interval 310 and the paging cycle 300 may have a duration that is an integer multiple of the length of the frames 312. Additionally, the frames 312 may be considered orthogonal frequency division multiple access (OFDMA) frames, although the invention is not limited to this particular embodiment.

Because the MSSs 112 only periodically monitor transmissions from the BSs 110 in idle mode, incoming traffic intended for the MSSs 112 can be received by the paging controller 116 and temporarily stored in the buffer 118. The MSSs 112 are capable of operating both time-critical and non-time-critical applications. As an example, a time-critical application can be a real-time application, like a PTT or VOIP call. Conversely, a non-time-critical application can be a non-real-time application, such as e-mail or Internet/Web browsing. It is understood, however, that the invention is not limited to these particular examples. In fact, a time-critical application can be defined as any application where connection set-up time is deemed as a priority. In contrast, a non-time-critical application can mean any application where connection set-up time is not a priority and a relatively longer delay in initiating the application is acceptable.

In view of the capabilities of the MSSs 112, the incoming traffic may be associated with various types of voice and data connections. Because some applications require a faster connection set-up time than others, the paging controller 116 may determine a priority of the incoming traffic. This determination may also occur when the incoming traffic is buffered in the buffer 118.

Referring to FIG. 4, the incoming traffic may be in the form of Internet Protocol (IP) packets 400, and the paging controller 116 may determine a priority of the incoming traffic by detecting a priority identifier 410. The term priority identifier can be defined as any suitable configuration of the incoming traffic that enables the priority of the incoming traffic to be determined. In one arrangement, the priority identifier 410 can be in a header 412 of the IP packet 400. As an example and as noted earlier, the priority identifier 410 can be a ToS flag, a TCP port number or a QoS field.

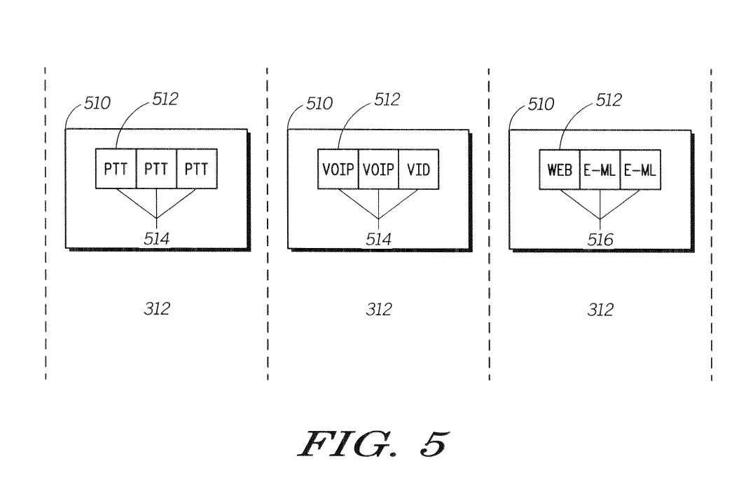

Referring back to FIG. 2, at step 218, a paging indication sequence of one or more paging messages can be ordered, such that higher priority identifier identifiers associated with time-critical applications are positioned in front of lower priority identifiers. Finally, at step 220, the paging messages can be transmitted to the MSSs during a listening interval of a paging cycle. To explain these steps, reference will be made to FIGS. 1 and 3 and also FIG. 5, which shows an example of several frames 312, each of which includes a paging message 510.

As noted earlier, the paging controller 116 can identify the priority of incoming traffic. The paging controller 116 can then signal the BSs 110 with such information. In response, the BSs 110 can order a paging indication sequence 512 of the paging message 510, which can be according to a predefined protocol or set of rules.

As an example, the paging indication sequence 512 can include higher priority identifiers 514 and lower priority identifiers 516. In one embodiment, the higher priority identifiers 514 may be associated with time-critical applications, and the lower priority identifiers 516 may be associated with non-real-time applications, examples of which were presented above. In one specific example but without limitation, the higher priority identifiers 514 and the lower priority identifiers 516 may be medium access control (MAC) address hashes. As is known in the art, an MSS 112 that operates in an 802.16e network can rely on these MAC address hashes to determine whether a paging message 510 is carrying information designated for that particular MSS 112. Once the order of the paging indication sequence 512 is set, the BS 110 can then transmit the paging messages 510 over the listening interval 310 of the paging cycle 300.

For purposes of the invention, a higher priority identifier can be defined as a form of data that can be processed by a mobile unit for informing the mobile unit of pending traffic and which is classified as important relative to other identifiers of a paging indication sequence. Conversely, a lower priority identifier can be defined as a form of data that can be processed by a mobile unit for informing the mobile unit of pending traffic and which is classified as less important relative to other identifiers (particularly, high priority identifiers) of a paging indication sequence. Moreover, a paging indication sequence can be defined as an arrangement of identifiers that inform mobile units of pending traffic, which includes higher priority identifiers and lower priority identifiers.

In one arrangement, the BSs 110 can position the higher priority identifiers 514 in front of the lower priority identifiers 516. Looking at the paging indication sequence 512, one can see that such a positioning scheme has been carried out here. As an example, the higher priority identifiers 514 may be associated with PTT or VOIP calls, and the lower priority identifiers 516 may be associated with e-mail or Web browsing. As a demonstration, the application with which the identifiers 514 and 516 are associated has been positioned on them in FIG. 5 (e-mail designated by “E-ML” and Web browsing designated by “WEB”). As pictured here, the paging indication sequence 512 runs across multiple frames 312. It is understood, however, that the invention is not so limited, as the paging indication sequence 512 can also run across a single frame 312.

Because the higher priority identifiers 514 are positioned in front of the lower priority identifiers 516, the paging messages 510 containing the higher priority identifiers 514 can reach the MSSs 112 before the paging messages 510 that include the lower priority identifiers 516. This process can reduce the connection set-up time for time-critical applications of the MSSs 112. For example, if a PTT call is to be initiated with an MSS 112, the higher priority identifier 514 associated with this PTT call can reach the appropriate MSS 112 before a lower priority identifier 516 associated with, for instance, an e-mail transmission reaches another MSS 112 on the same paging group. It must be noted that the invention is not limited to this particular example, as the type of applications that the MSSs 112 can operate are numerous and can be expanded, given the advance of technology. Moreover, the priority of these applications can be modified at any time by changing the set of rules or protocol for ordering the paging indication sequences 512.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for setting a paging indication sequence in paging messages, comprising:
in a mixed media environment, receiving incoming traffic designated for one or more mobile stations in a paging group, wherein the mobile stations are capable of operating time-critical applications; and
ordering the paging indication sequence of the paging messages such that higher priority identifiers associated with the time-critical applications are positioned in front of lower priority identifiers to reduce the set-up connection time for the time-critical applications of the mobile stations.

2. The method according to claim 1, further comprising:
buffering the incoming traffic designated for the mobile stations; and
ordering the paging indication sequence of the paging messages while the incoming traffic is buffered.

3. The method according to claim 1, further comprising transmitting the paging messages to the mobile stations during a listening interval of a paging cycle.

4. The method according to claim 3, wherein the listening interval is comprised of one or more frames.

5. The method according to claim 1, wherein the time-critical applications are real-time applications and the lower priority identifiers are associated with non-real-time applications.

6. The method according to claim 5, wherein the real-time applications include push-to-talk (PTT) calls and voice over internet protocol (VOIP) calls and the non-real-time applications include e-mail and Web browsing.

7. The method according to claim 1, wherein the incoming traffic is comprised of Internet Protocol (IP) packets and the method further comprises determining a priority of the incoming traffic by detecting a priority identifier in the IP packet.

8. The method according to claim 7, wherein the priority identifier is a Type of Service (TOS) flag, a Transmission Control Protocol (TCP) port number or a Quality of Service (QoS) field.

9. The method according to claim 1, wherein the mixed media environment is contained within a communications network that operates in accordance with the institute of Electrical and Electronics Engineers (IEEE) standard 802.16e.

10. A communication network for setting paging indication sequences in paging messages, comprising:
a buffer that receives incoming traffic designated for one or more mobile stations in a paging group, wherein the mobile stations are capable of operating time-critical applications; and
a paging controller operatively coupled to the buffer, the paging controller orders the paging indication sequence of the paging messages such that higher priority identifiers associated with the time-critical applications are positioned in front of lower priority identifiers to reduce the set-up connection time for the time-critical applications of the mobile stations, wherein the communication network is a mixed media environment.

11. The network according to claim 10, wherein the paging controller orders the paging indication sequence of the paging messages while the buffer buffers the incoming traffic.

12. The network according to claim 10, further comprising a transmitter that transmits the paging messages to the mobile stations during a listening interval of a paging cycle.

13. The network according to claim 10, wherein the time-critical applications are real-time applications and the lower priority identifiers are associated with non-real-time applications.

14. The network according to claim 13, wherein the real-time applications include PTT calls and VOIP calls and the non-real-time applications include e-mail and Web browsing.

15. The network according to claim 10, wherein the incoming traffic is comprised of IP packets and the paging controller determines a priority of the incoming traffic by detecting a priority identifier in the IP packet.

16. The network according to claim 15, wherein the priority identifier is a ToS flag, a TCP port number or a QoS field.

17. The network according to claim 10, wherein the network operates in accordance with the IEEE standard 802.16e.

18. A machine readable storage, having stored thereon a computer program having a plurality of code sections executable by an electronic device for causing the electronic device to:
in a mixed media environment, receive incoming traffic designated for one or more mobile stations in a paging group, wherein the mobile stations are capable of operating time-critical applications; and
order a paging indication sequence of paging messages such that higher priority identifiers associated with the time-critical applications are positioned in front of lower priority identifiers to reduce the set-up connection time for the time-critical applications of the mobile stations.

19. The machine readable storage according to claim 18, wherein the computer program further causes the electronic device to:
buffer the incoming traffic designated for the mobile stations; and
order the paging indication sequence of the paging messages while the incoming traffic is buffered.

20. The machine readable storage according to claim 18, wherein the time-critical applications are real-time applications and the lower priority identifiers are associated with non-real-time applications.
